(19) United States
(12) Patent Application Publication
(10) Pub. No.: US 2011/0153481 A1
(43) Pub. Date: Jun. 23, 2011

(54) SYSTEM AND METHOD FOR MANAGING FINANCIAL ACCOUNTS AND COMPARING COMPETITIVE GOODS AND/OR SERVICES RENDERED THERETO

(76) Inventor: John H. Hamby, Cromwell, CT (US)

(21) Appl. No.: 12/973,240

(22) Filed: Dec. 20, 2010

Related U.S. Application Data
(60) Provisional application No. 61/284,462, filed on Dec. 18, 2009.

(51) Int. Cl. G06Q 40/00

(52) U.S. Cl. 705/35

(57) ABSTRACT

A system and method is presented for comparing competitive goods and/or services. The method including steps of receiving, by a processor, first pricing schedule information including fees assessed for providing the goods and/or services to a customer by a first institution, and determining fees incurred by one or more accounts maintained by the customer during a predetermined time period at the first institution per the first pricing schedule information. The method also includes receiving a second pricing schedule information including fees assessed for providing the goods and/or services to the customer by a second institution, and determining fees incurred by the accounts at the second institution per the second pricing schedule information. The method compares the fees determined for maintaining the more accounts at the first institution and at the second institution, and presents a report to the customer including the comparison of the fees.

### CROSS-REFERENCE TO RELATED APPLICATIONS

This patent application claims priority benefit under 35 U.S.C. §119(e) of copending, U.S. Provisional Patent Application Ser. No. 61/284,462, filed Dec. 18, 2009, the disclosure of this U.S. patent application is incorporated by reference herein in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the United States Patent and Trademark Office files or records, but otherwise reserves all copyright rights whatsoever.

### BACKGROUND OF THE INVENTION

1. Field of the Invention

This invention relates generally to systems and methods for managing financial accounts of others. In particular, the present invention relates to systems and methods for managing one or more accounts, for example, commercial checking and other customer accounts, by assisting financial institutions in presenting product proposals including one or more schedules of fees, costs and the like, of the products for retaining existing and attracting new customers.

2. Description of Related Art

Depositors maintain, at one or more banks and other financial institutions, one or more interest and non-interest bearing accounts. Some institutions move amounts of money from one account to another account so that its customers may earn interest or receive another credit on funds within its accounts. For example, money may be moved from a non-interest bearing account overnight to an interest bearing account or other investment vehicle, such that the depositor receives a hard dollar interest return on its money in what are generally referred to as “sweep” transactions. Rather than, or in addition to, sweep transactions, institutions may employ “earnings credits” (ECs) based upon funds in one or more accounts of its customers. ECs may be applied by the institution to offset or reduce (fully or partially) fees, costs and the like, of services provided by the institution to the customer. Often, customers select banks and other financial institutions based at least upon the “value” the customer receives (e.g., interest, ECs, and the like) from funds it maintains in its accounts. As such, competitive advantage can be achieved from effectively demonstrating value to new and existing depositors/customers.

Many banks and other financial institutions determine and communicate to their customers, monthly, with an activity and pricing accountability report (e.g., a monthly account statement). The report/statement typically contains, for example:

1. A statement of average monthly “investible balances”, which are computed by starting with average ledger balances, subtracting uncollected funds representing the average amount of dollars for checks being collected and then subtracting a predetermined percentage per a Federal Reserve requirement or “reserve”, which requires banks to maintain a percentage of balances (e.g., 10%) at the US Federal Reserve Bank. The result is deemed to be a net amount (investible balances) that a bank has to employ for loans, investments, or to hold as cash.

Traditionally, the Federal Reserve Bank paid no interest on “reserves” it held. Recently, the Federal Reserve Bank commenced paying banks a modest interest on such reserves. It can be assumed that bank statements will, in time, reflect this policy change.

2. The typical statement then computes a cost or price (e.g., fees, cost and the like) of maintaining one or more accounts and/or related goods and/or services rendered to the customer and which the bank has declared eligible for reduction through the application of an inputted value referred to hereinafter as an Earning Credit Rate (ECR) to investible balances. Some banks may deduct a loan usage percentage or amount from investible balances before applying the ECR credit, but such deduction is rare.

Checking account services typically include a monthly statement fee, itemized charges for checks paid, checks deposited, deposits made, Automated Clearing House (ACH) debit and credit transactions, returned deposited checks, coin and currency services rendered, and Automated Teller Machine (ATM) card/debit card transactions. Some banks may include charges for uncollected funds transaction and overdrawn account charges. Some banks may include other charges for services deemed closely related, such as wire transfers and payroll services. Service fees for “Sweeping Services” may also be included. While all bank fees are eligible for ECR related charge reductions, liberal/broad applications are not common in the industry.

3. The ECR is typically stated as an annual rate but utilized as a monthly rate credit. Banks may utilize a single rate for all accounts or may apply a plurality of ECRs based on, for example, a “tiered” rate schedule dependent on the balances maintained by its customers. Rates are typically set by the financial institution on a periodic basis (e.g., monthly, quarterly, and the like) and may be tied to an industry benchmark such as, for example, a ninety (90) day U.S. Treasury bill rate being, historically, the most common.

4. A resultant credit (e.g., the earnings credit or EC referenced above) is subtracted from the combined cost of eligible service fees contained on the statement. If the EC is sufficient to offset service fees, no net service charges from eligible services are charged to the customer that month. Otherwise, the combined charges are reduced by the EC and the balance charged is assessed to (e.g., debited from) the customer's account.

5. Some banks may combine the results of more than one account in an analysis. Single account analysis practices are most common.

6. Any unutilized ECs typically expire at month's end. In some cases, ECs are carried forward to a next month and are available for service fee reductions incurred at a later time. A carry forward may be determined by the financial institution with a month, end of year, or one year being the most typical selections. There is no mandated expiration period although expiration upon the account's closing is recommended.

7. Customers with large on-hand balances, for example, amounts including moderate to mid six figures collected balances or more, and/or excess balance amounts above the amount necessary to reduce eligible service fees to zero, may choose to have funds “swept” overnight to an interest bearing investment/account. So called “sweep” fees may be included in the commercial checking analysis.

8. Customers with “sweep” services may receive a separate statement indicating daily activity, interest earned and fees incurred.

As noted above, customers review these reports and statements, compare and select from competitive financial institutions based at least upon the value the customer receives (e.g., interest, ECs, and the like) from funds it maintains in its accounts. Accordingly, the inventor has recognized that a tool for demonstration an institution's competitive advantage in providing such value is needed.

### SUMMARY OF THE INVENTION

The present invention includes, in one aspect, a computer-implemented method of comparing competitive goods and/or services. The method including a step of receiving, by a processor, first pricing schedule information including fees assessed for providing goods and/or services to a customer by a first institution. The method then determines fees incurred by one or more accounts maintained by the customer during a predetermined time period at the first institution in accordance with the first pricing schedule information. The method also includes receiving a second pricing schedule information including fees assessed for providing goods and/or services to the customer by a second institution. The method then determines fees incurred by the one or more accounts maintained by the customer during the predetermined time period at the second institution in accordance with the second pricing schedule information. The method also includes comparing the fees determined for maintaining the one or more accounts at the first institution to the fees determined for maintaining the one or more accounts at the second institution. Additionally, the method includes presenting, on an output device coupled to the processor, a report to the customer including the comparison of the fees.

In one embodiment, the first institution is a current provider of the goods and/or services to the customer, and the second institution is a prospective provider of the goods and/or services to the customer. A financial service person of the second institution may provide the comparison report to the customer in order to induce the customer to move its accounts to the second institution. In one embodiment, the output device is a display device such as a monitor, and the presenting step includes exhibiting the report as a user interface on the display device. In another embodiment, the output device is a printer and the presenting step includes printing the report for the customer to review.

In yet another embodiment, at least one of the first pricing schedule information and the second pricing schedule information includes a plurality of price levels of fees of the goods and/or services. In one embodiment, the one or more of price levels includes a tiered pricing approach. The tiered approach permits the definition of one or more thresholds at which fees for goods and/or services pass from a first price level to a second price level. For example, the tiered pricing approach may recognize a distinction in a value of monetary funds held in the one or more accounts of the customer.

In another aspect of the invention, a system is provided for comparing competitive goods and/or services provided to account holders. The system includes a processor coupled to memory and an input-output controller, an input device coupled to the input-output controller, computer implemented methods stored in the memory, and a display device coupled to the input/output controller. In one embodiment, the input device provides to the system data and information including balances in one or more accounts of an account holder, a schedule of current charges assessed by a financial institution to the one or more accounts, and a schedule of prospective charges to be assessed to the one or more accounts. The computer implemented methods are executed by the processor to determine and compare performance at a present financial institution and at a prospective financial institution. The display device exhibits to the customer comparison data detailing performance at the present financial institution and the prospective financial institution.

### BRIEF DESCRIPTION OF THE DRAWINGS

FIG. 1 is a simplified schematic block diagram of a BALANCE BUILDER™ system providing enhanced management of financial accounts, in accordance with one embodiment of the present invention;

FIG. 2 is a representation of a graphical user interface depicting a Main or Navigation interface of the Balance Builder system of FIG. 1, in accordance with one embodiment of the present invention;

FIG. 3 is a representation of an Installed Bank Defaults graphical user interface of the Balance Builder system of FIG. 1, in accordance with one embodiment of the present invention;

FIG. 4 is a representation of a Competitor Pricing Defaults graphical user interface of the Balance Builder system of FIG. 1, in accordance with one embodiment of the present invention;

FIG. 5 is a representation of a Present Provider institution graphical user interface of the Balance Builder system of FIG. 1, in accordance with one embodiment of the present invention;

FIG. 6A is a representation of a Prospective Provider institution graphical user interface of the Balance Builder system of FIG. 1, in accordance with one embodiment of the present invention;

FIG. 6B is a representation of the Prospective Provider institution graphical user interface of FIG. 6A, in accordance with another embodiment of the present invention;

FIG. 7 is a representation of a Prospective Provider Summary Results with Price Modification Tool graphical user interface of the Balance Builder system of FIG. 1, in accordance with one embodiment of the present invention;

FIG. 8 is a representation of a Notes graphical user interface of the Balance Builder system of FIG. 1, in accordance with one embodiment of the present invention; and

FIGS. 9A and 9B depict summary reports provided by the Balance Builder system, in accordance with one embodiment of the present invention.

### DETAILED DESCRIPTION OF THE PREFERRED EMBODIMENTS

The present invention provides a novel system and method for managing financial accounts of customers. In one embodiment, a BALANCE BUILDER™ system, as described herein, provides computer-implemented tools and methods that enable banks and other financial institutions of all sizes to build desirable account balances, e.g., commercial checking account balances, through the use of imaginative product pricing and presentation methodologies. The tools and methodologies are effective, contain new concepts not employed by banks and financial institutions, permit the implementation of the tools and methodologies in a format that does not depend on costly main frame computer program and system changes, and offer new, tailored individual account solutions and specialized group adaptations at modest cost. In one embodiment, the present Balance Builder system improves management of financial accounts of customers including, in particular, commercial checking accounts and attendant “sweep” activity. Balance Builder is a trademark of Advanced Business Banking Solutions LLC, East Berlin, Conn. USA. It should be appreciated that while the present disclosure refers to banks and other financial institutions, the scope of the present invention broadly applies to any entity that maintains financial accounts holding funds of its customers.

Generally speaking, objectives of building account deposits, e.g., commercial checking account deposits, focuses on several key actions including, for example:

1. Retaining and building balances of existing customers.

2. Increasing the amount of analyzed costs as a retention and growth strategy.

3. Creating methodologies to encourage bank customers to reduce account swept activity overnight to interest paying instruments.

4. Providing for enhanced value to customers through improved institutional recognition of the value of commercial checking balances.

5. Providing easily employed indices to determine and control the cost/value result from pricing actions taken.

6. Attracting new accounts through imaginative and attractive value propositions not offered by competitors.

In one embodiment, the Balance Builder system enhances conventional account management systems by implementing functionality that allows financial service personnel to demonstrate account features, including “what if” projections with respect to cost and earning expectations, to new and existing customers. In one embodiment, the Balance Builder system is implemented on a portable computing device such as laptop, tablet, notebook, a personal digital assistant (PDA), a mobile communication device having processing capabilities, Internet-enabled mobile radiotelephone, pager or like portable computing devices, or any other suitable processing device executing a Microsoft® Access® programming platform. It should be appreciated that the scope of the present invention broadly applies to any standalone or networked computing device. Microsoft and Access are registered trademarks of Microsoft Corporation, Redmond, Wash. USA. The implementation of the Balance Builder system permits evaluating, computing and/or comparing alternatives and unique financial service strategies. For example, the Balance Builder system includes all the functionality of desired financial analysis programs. It also provides unique enhancements and pricing/product profile choices that can make a meaningful difference to financial institutions with higher growth, profit and retention objectives.

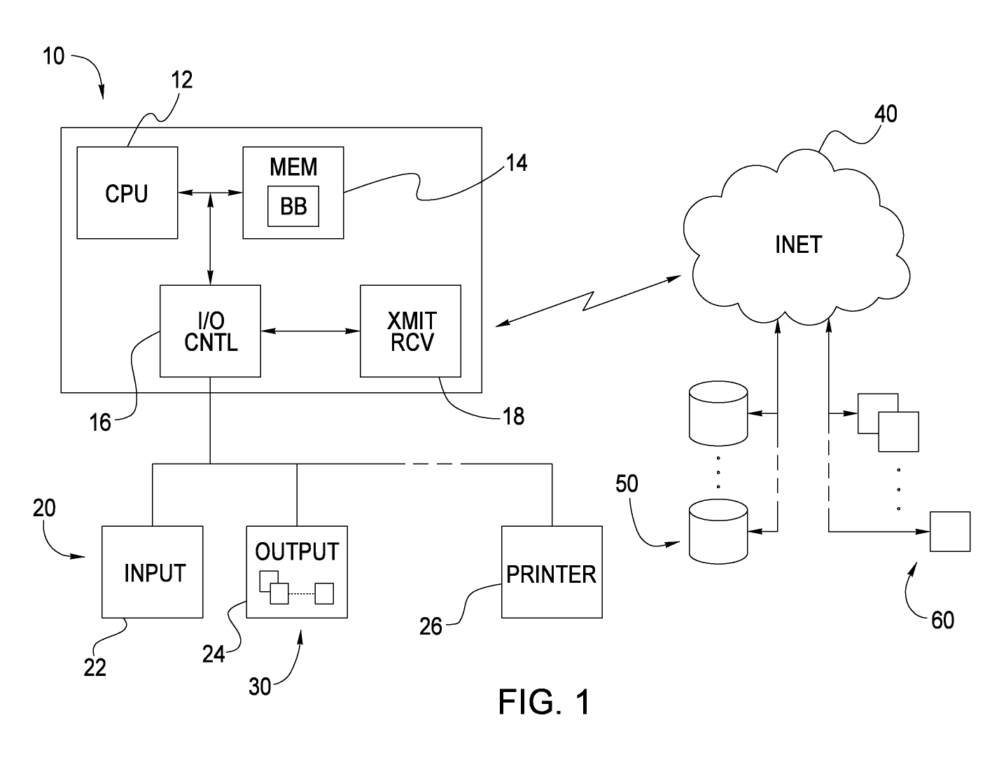

As shown in FIG. 1, a Balance Builder system 10 is configured and operates in accordance with one embodiment of the present invention to implement techniques, as described herein, for collecting, storing, computing, displaying and distributing financial information to one or more customers, account holders and/or personnel of a financial institution demonstrating products and/or performance to customers and/or account holders. As shown in FIG. 1, the system 10 includes a processor such as a microprocessor or CPU 12, computer-readable medium or memory 14, an input-output controller 16 operatively coupled to input and output devices, shown generally at 20, including an input device 22 for facilitating input of data and information to the system 10 such as a keyboard, a mouse, light pen pointing device, document scanner, or other input device, and output devices for displaying inputted and/or processed data and other information such as a pixel-oriented display device 24, printer 26 or the like. In one embodiment, the Balance Builder system 10 includes a transceiver 18 operatively coupled to a communications network 40 such as the Internet, an intranet, an extranet, or like distributed communication platform for accessing one or more storage devices 50 and/or sending and receiving data, information, commands, and otherwise communicating with one or more external devices 60 over wired and wireless communication connections.

The processor 12 executes computer-implemented steps including Balance Builder (BB) financial planning methods 14A stored in the memory 14 such that a person (e.g., financial service personnel, account holder and/or banking customer) operating the system 10 may invoke and execute the planning methods BB 14A, review results exhibited on the display device 24 and make decisions regarding various financial accounts. It should be appreciated that the computer-implemented planning methods BB 14A generally require manipulation of data in the form of electrical, magnetic and/or optical signals that may be inputted, stored, transferred, combined, compared, or otherwise manipulated to provide a desired result. In one embodiment, a desired result includes visual representations of one or more data and information for managing financial accounts. For example, the planning methods BB 14A may direct the processor 12, input-output controller 16 and display 24 to exhibit one or more user interfaces, e.g., application generated user interfaces, web pages, and the like, shown generally at 30, for comparing schedules of fees, costs and the like, of goods and/or services of one or more banks and other financial institution. In one embodiment, competitive institutions and/or product lines within one institution, or between two or more institutions, are compared to promote more informed decision making in the management of one or more accounts of an account holder. One embodiment of the user interfaces 30 depicting the Balance Builder system 10 and computer-implemented Balance Builder financial planning methods BB 14A is described below.

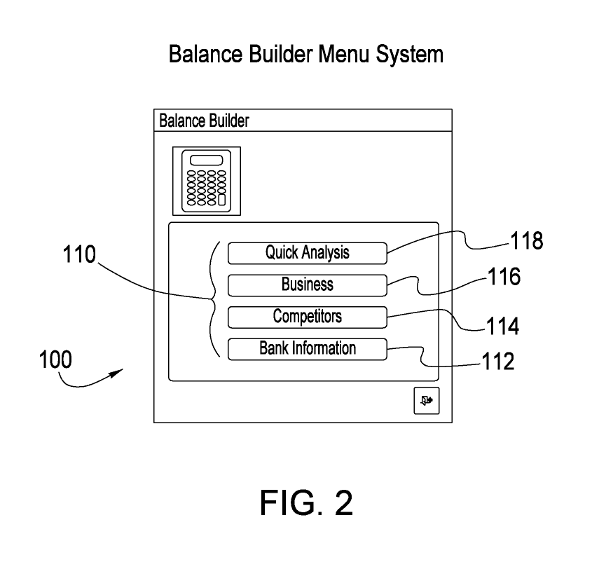

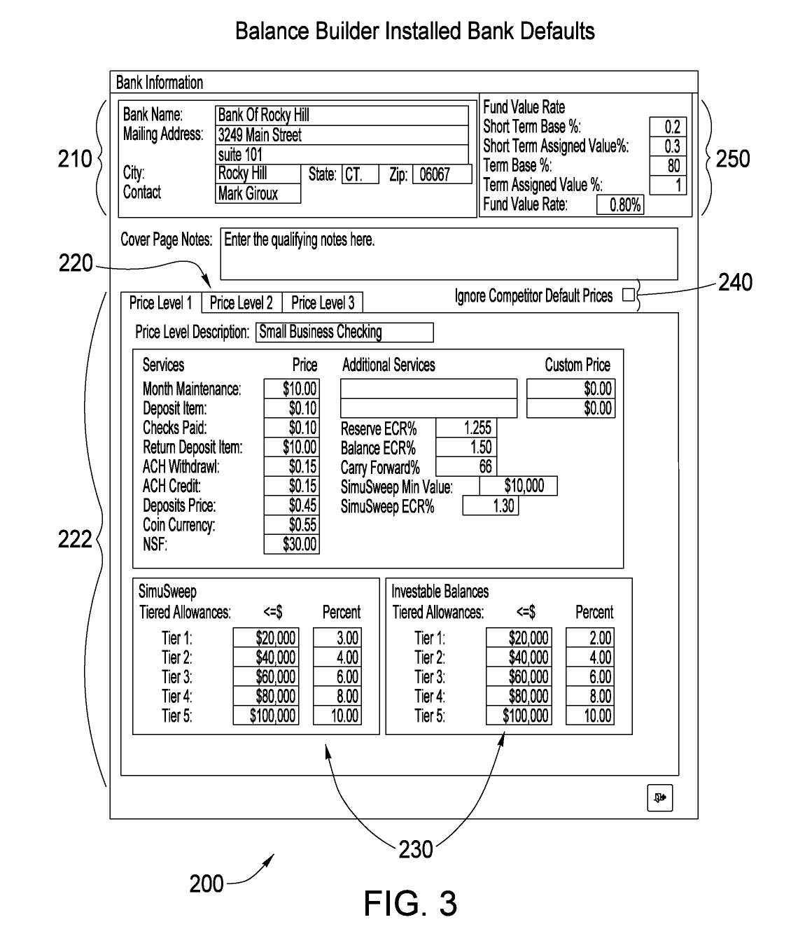

FIG. 2 depicts a Balance Builder navigation/home page user interface 100, in accordance with one embodiment of the present invention. The Balance Builder navigation interface 100 is initially exhibited on the display device 24 of the Balance Builder system 10 (e.g., as one of the user interfaces 30). As shown in FIG. 2, the Balance Builder navigation interface 100 includes a plurality of access controls 110 that, when selected, invoke more detailed input, process or control user interfaces for initiating one or more features and functions of the Balance Builder system 10, namely, one or more features and functions of the computer-implemented Balance Builder financial planning methods BB 14A as described herein. For example, selecting a Bank Information control 112 invokes an Installed Bank Defaults user interface 200 (FIG. 3). At the Installed Bank Defaults interface 200, a user may view, input and/or modify various characteristics of a subject bank. For example, general identification information is inputted, exhibited and may be modified at identification fields, shown generally at 210, including name, address, point of contact, and other information and data. While not discussed in detail herein, it should be appreciated that it is within the scope of the present invention to validate or otherwise verify data and information received via input fields, such as the identification fields 210, of each of the user interfaces presented within the Balance Builder system 10. Moreover, it is within the scope of the present invention to employ tutorials, help screens, context sensitive field definition “pop-ups” and the like, to assist in the use and understanding of the Balance Builder system 10 and its features and functions.

Referring again specifically to FIG. 3, as shown generally at 220, a plurality of price levels and/or schedules (e.g., price level 1 through price level 3 shown) of fees, costs and the like, of goods and/or services are presented on the Installed Bank Defaults user interface 200. Each of the plurality of schedules 220 exhibits and records a plurality of fees, costs or pricing plans that itemize charges assessed by an institution to customers. For example, as shown generally at 222, fields of a price level 1 schedule are exhibited and may receive inputted and/or modified entries to document costs a subject bank assigns to various goods and/or services provided to its customers. For example at 222 fees and costs a subject bank (e.g., The Bank of Rocky Hill as shown at 210) are initially entered and/or later reviewed and/or modified, including a price assessed for monthly maintenance, deposit item, check paid, ACH debit/credit, and the like. As shown generally at 230, a tiered allowance approach may be defined and applied to one or more portions of balances in one or more accounts of customers of the bank. For example, a tiered approach (e.g., Tier 1 to Tier 5) is used to assign amounts and/or percentages for “SimuSweep” and other activities, investible balances, and the like. One or more fields within the tiered approach are exhibited and may be receive input to record and/or modify a value (required amount or percentage threshold). As described below, the subject bank's characteristics (e.g., pricing 222 and allowance 230 characteristics) may be defaulted to predetermined values such as, for example, an identified competitor's characteristics, by selecting/deselecting a default pricing control 240. In one embodiment, for example, the default pricing control allows a user to “use” or “not use” previously saved competitor bank pricing. If not used, the user is effectively creating a customized pricing plan for the bank.

As shown generally at 250, the Balance Builder system 10 determines and exhibits to the user, Full Value Rate fields including, for example, a percentage rate that the institution determines is a long term value to the institution for balances maintained by its customers. A short term percentage rate, typically representing short term money market rates, is applied to that part of the customer's total balances that are subject to fluctuation. The remaining portion of balances is treated as static. This remaining static portion is given value at, for example, a three to four (3 to 4) year rate. A resulting weighted average develops what is termed the Full Value Rate. The Full Value Rate feature is seen to allow institutions the freedom of developing creative proposals for its schedules 220 within a framework of accepted account balance values (e.g., thresholds). In one embodiment, the rate is indexed with, for example, one hundred (100) representing ECR by the institution in a particular situation providing ECs equivalent to one hundred percent (100%) of the developed account value as determined by the institution. From there, the institution can set guidelines as to recommended pricing/schedules, exception pricing/schedules and the like. It should be appreciated that the percentage rates and account balance thresholds exhibited at 222 and 250 are exemplary. In today's market, weighted averages are reasonably determined and applied at twenty-five percent (25%) short term to the fluctuating balance at, for example, eighteen hundreds of a percent (0.18%) and a four (4) year rate of seventy-eight hundredths of a percent (0.78%) for the remaining seventy-five percent (75%) of the static account balance. In one embodiment, the weighted average and Full Value Rate is about fifty-nine hundreds of a percent (0.59%). The 0.59% would establish, for example, the 100 Full Value Rate Index. Institutions utilize such valuations in a “Profit Center” analysis operation.

As illustrated in FIG. 3, one embodiment of the Installed Bank Defaults user interface 200 exhibits an institution's elected choices of one of a plurality of pricing schedules 220, which can be substantially different. In FIG. 3, choices can be made from up to three (3) pricing schedules (e.g., Price Level 1 to Price Level 3, shown). Possible utilizations of this choices pricing schedule presentation may include, for example, a first schedule for “small” sized business entities having average balances in a first predetermined range, a second schedule for “moderate to large” sized business entities having average balances in a second predetermined range, and a third schedule for “special” and/or “very large” sized business entities and/or preferred customers/prospects. The choice of a schedule is a place to start. In all cases, the user of the Balance Builder system 10 can tailor widely with respect to, for example, service and product pricing and tier allowance thresholds. The Balance Builder system 10 allows an institution to establish a percentage of collected balances to be categorized as “reserves.” Many businesses dislike the practice of financial institutions making a reserve deduction before calculating ECs. Some customers see reserves as a “bank cost” and prefer to get their ECs based on a rate for collected balances rather than the prevailing “investable balances” approach. Financial institutions that react to that business feeling can simple reduce the system defined reserve percentage to zero. Those institutions would then choose to present a collected balance rate which, internally, incorporates the fact that the institution receives the government lower rate on ten percent (10%) of balances.

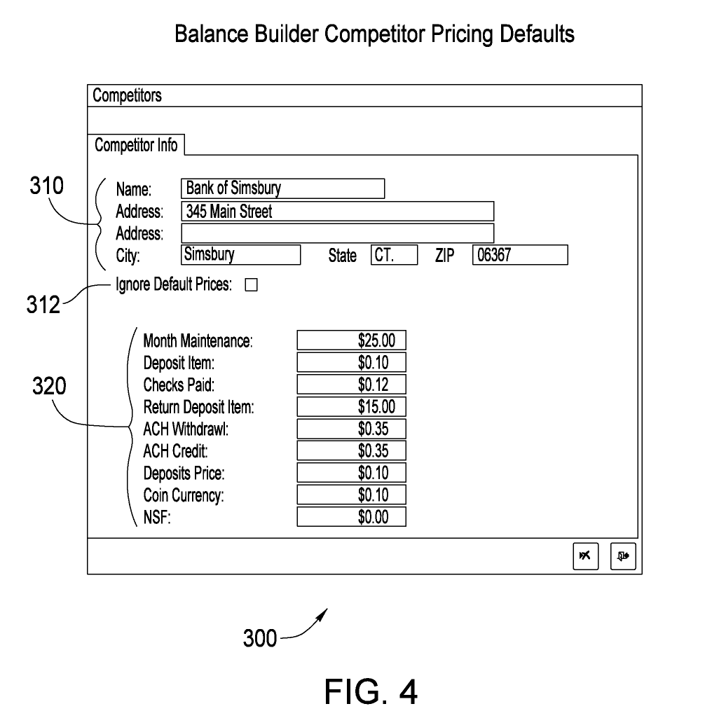

Returning again to the Balance Builder navigation interface 100, a Competitors control 114 invokes a Competitor Pricing Defaults user interface 300 (FIG. 4). At the Competitor Pricing Defaults interface 300, a user may view, input and/or modify various characteristics of one of a plurality of identified competitors to the subject bank. It should be appreciated, of course, that the “competitor” may include the subject banks, for example, the present provider of goods and/or services, and that the “competitor” in that instance may be a new or different product, e.g., pricing schedule as compared to a current schedule. In FIG. 4, general identification information is inputted, exhibited and may be modified at identification fields shown generally at 310. Generally speaking, current pricing information from a competitor/present provider can be input in the Competitor Pricing Defaults user interface 300. At 320, default pricing information is initially inputted or populated within the fields of the interface 300. The pricing information may be reviewed and/or modified to document costs a competitor charges its customers for various services provided to the customers. In one embodiment, populating fields with default values is seen as a convenience to assist input. At 312, a control is presented to selectively activate and de-activate the default initial input feature. As described below, the competitor pricing is compared to the subject bank's pricing to demonstrate possible financial improvements to earnings and/or savings a customer can realize if they switch from the competitor institution and its current schedule of fees and cost, to the subject financial institution's schedule for optimizing management and return on investments of one or more of their financial accounts.

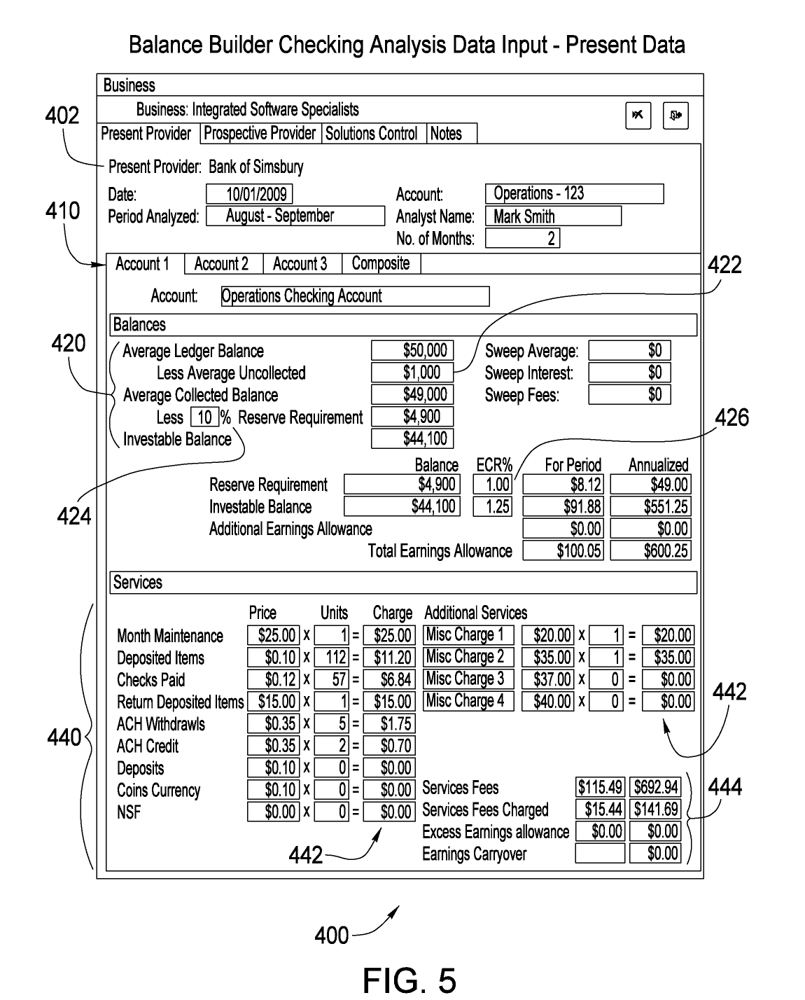

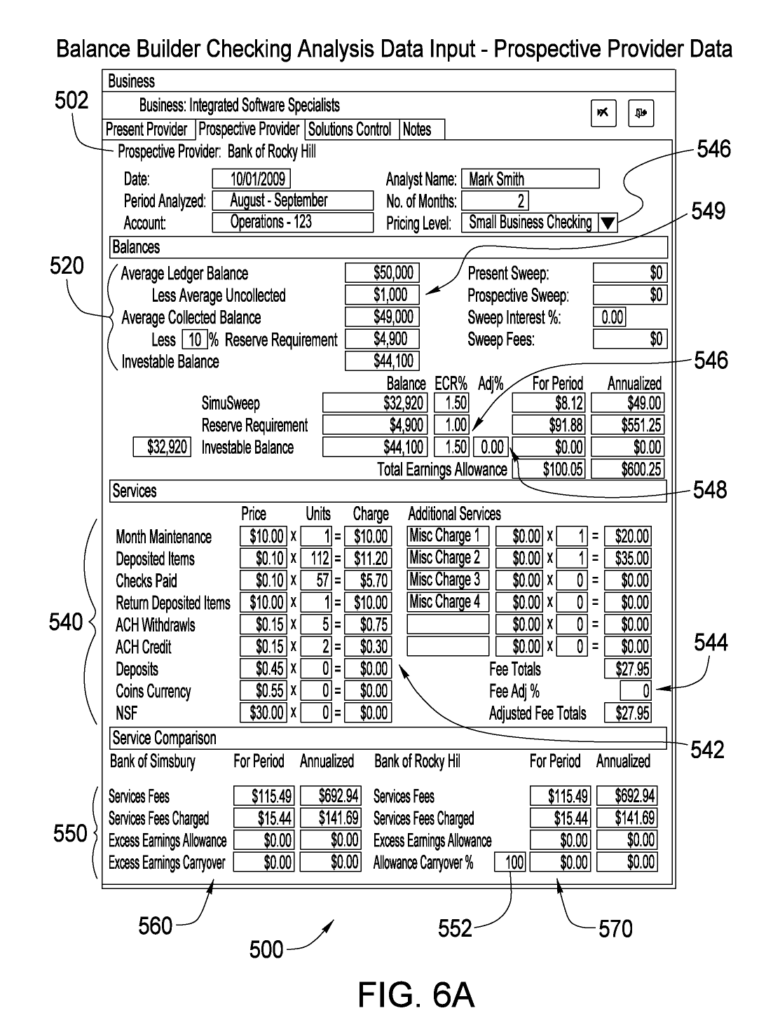

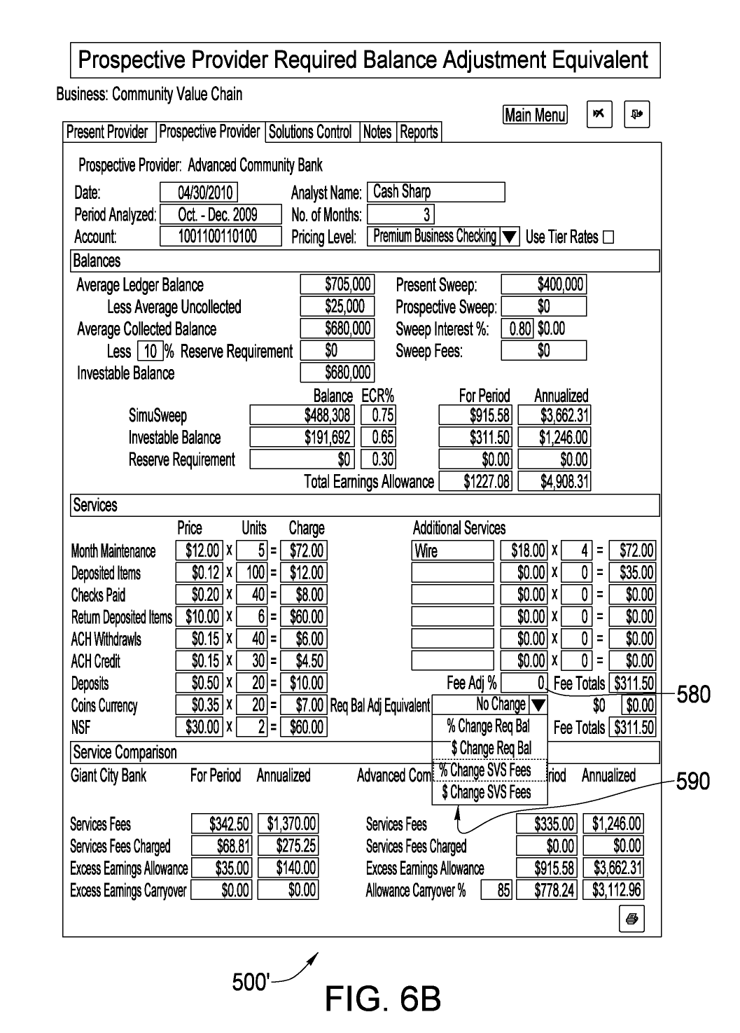

Returning again to the Balance Builder navigation interface 100 (FIG. 2), a Business control 116 invokes one of a plurality of user interfaces 400, 500, 600 and 700 (FIGS. 5-8) that allow input, viewing and performance analysis of one or more accounts of a customer held at a Present Provider institution 402, via an interface 400 (FIG. 5) as compared to a Prospective Provider institution 502, via an interface 500 (FIG. 6A). The features and functions of these interfaces are described below. At FIG. 5, a Checking Analysis Data Input interface 400 for the Present Provider 402 is depicted. As shown in FIG. 5 generally at 410, the performance analysis, as described herein, may be provided as a combined analysis for a plurality of accounts (e.g., accounts 1-3 and a composite account shown) over a predetermined time period (e.g., monthly, quarterly, and the like). The plurality of accounts 410 may or may not be organizationally related. In one embodiment, information with respect to a present financial institution (e.g., “The Bank of Simsbury” identified at 402) providing services to the customer is inputted and/or exhibited in the Present Provider interface 400. For example, at 420, average balance information for a specified time period is inputted, viewed and/or modified, at 422 an average uncollected funds amount may be manually altered, at 424 a “Reserve Requirement” may be set to any level (typically not above 10%, but including zero %), and at 426 the ECR for the reserves may be set at any level (including zero %). Once account holder average data is inputted, projected service fees, charges and allowance are determined and exhibited on the Present Provider interface 400 generally at 440. For example, performance per unit 442 and performance per period summary 444 of the services, are exhibited.

Similarly, the Prospective Provider interface 500 (FIG. 6A) enables input, review and modification of average balance information 520 and exhibits projected service fees, charges and allowance, generally at 540. For example, as shown at 542 a plurality of bank service costs are lists as services eligible for fee reduction (e.g., including using earning credits outside the checking analysis to reduce service costs to the bank customer), as shown at 544 a total service fee pricing amount may optionally be increased or decreased by a manually defined or predetermined percentage, as shown at 546 an ECR is set on investible balances based on a selected fixed or tiered rate table, as shown at 548 an adjustment to the table is provided by basis points addition or subtractions to the ECR rate, as shown at 549 an adjustment to provide a different/typically higher “SimuSweep” ECR for selected amounts of collected balances (typically, but not mandated balances in excess of those required to reduce eligible fee service charges to zero), and as shown at 552 a setting may be invoked to permit “carry forward” of unutilized “earnings credits” in total or as a selected percentage of the total. Alternatively, the carry forward amount may also be adjusted by an “ad hoc” implemented dollar amount of investible balances not subject to carry forward consideration. At 550, the performance of the present provider 560 (e.g., Bank of Simsbury) and the prospective provider 570 (e.g., Bank of Rocky Hill) are exhibited in a side-by-side manner to assist comparison and decision making as to preferred performance.

In one embodiment, illustrated in FIG. 6B, an alternative Prospective Provider interface 500′ is presented. At 580 of the alternative Prospective Provider interface 500′ the optional total service fee pricing amount adjustment (e.g., optional increase or decrease by a manually defined or predetermined percentage as shown in FIG. 6A at 544) is still present. Additionally, the alternative Prospective Provider interface 500′ includes Required Balance Adjustment Equivalent field 590 for implementing an optional adjustment (e.g., increase or decrease) of a required balance amount. As shown at 590, in one embodiment, the Required Balance Adjustment Equivalent field 590 is implemented with a “drop down” control that provides an ability to adjust the required balance amount by, for example, an entered monetary threshold or a percentage. The drop down control may permit a monetary threshold or percentage adjustment to both the total service fee pricing amount and the required balance amount.

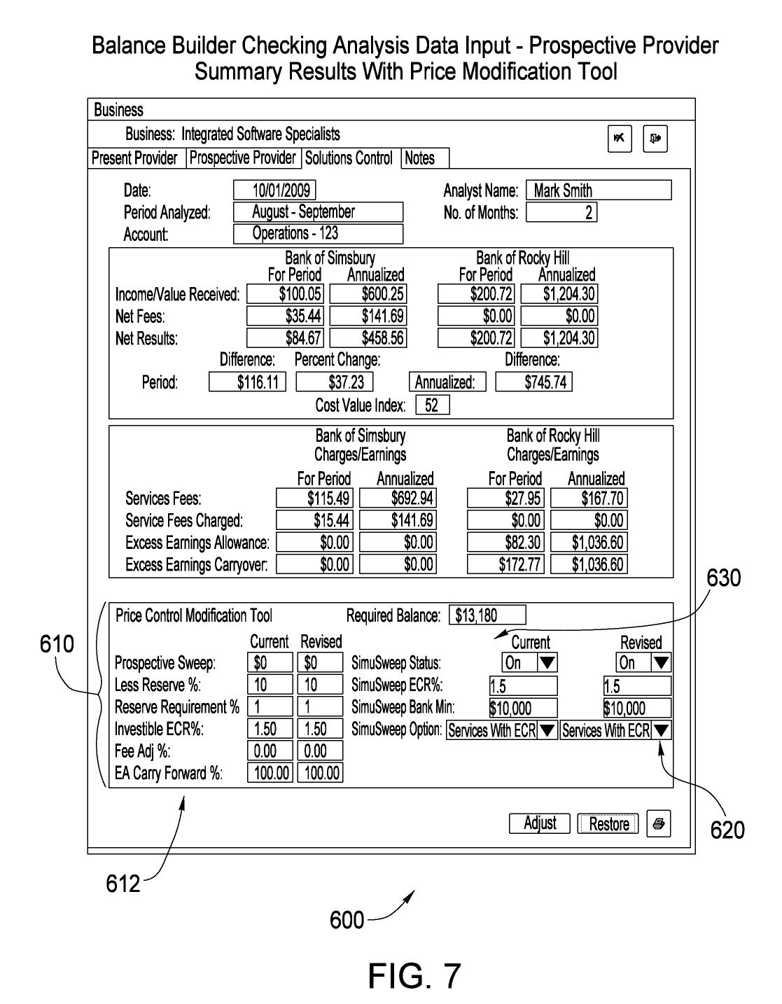

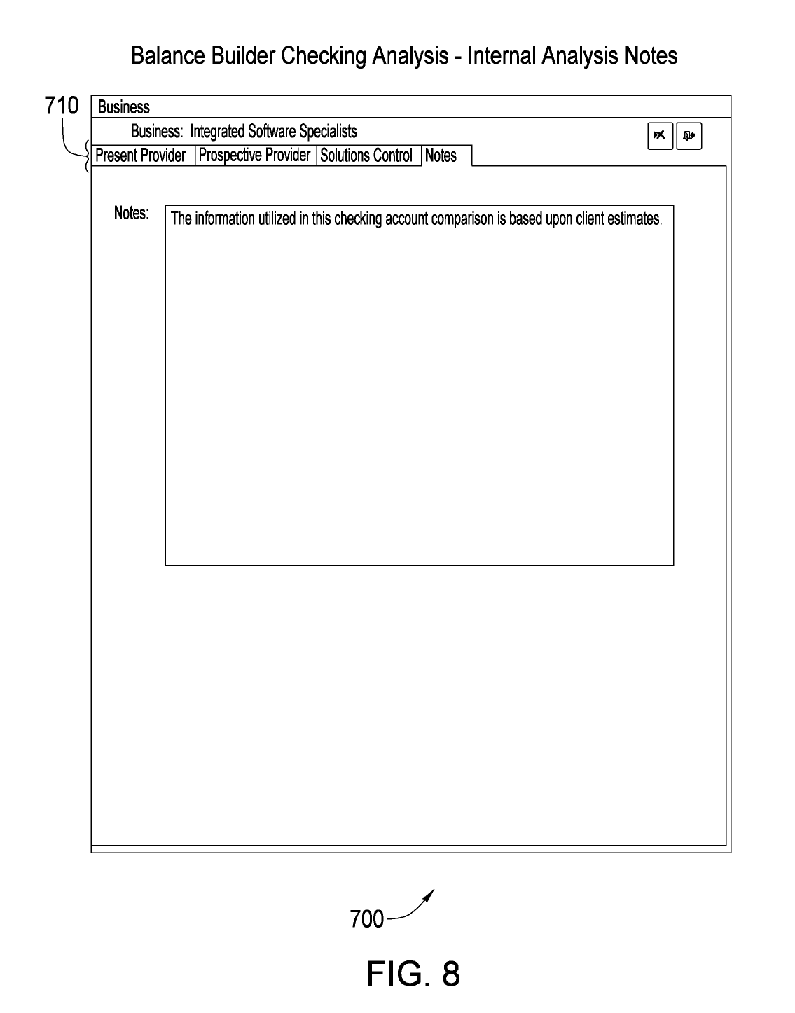

In a Prospective Provider Summary Results with Price Modification Tool interface 600 depicted in FIG. 7, pricing solution controls are implemented at 610. For example, at 612, table based rates and altered rates are retained, as well as adjustments to other elements, until accepted or rejected by the user/reviewer. That is, the Balance Builder system 10 provides an “Adjustment Control Board” to make adjustments within a visible adjusted results environment after initial pricing factor setting. Optionally, at 620, the “SimuSweep” ECR can be applied to a percentage of collected balances required reducing fee service charge to zero or on a percentage or set dollar amount after the zero service fee amount has been achieved. As shown at 630, Balance Builder system 10 automatically calculates and displays continually the dollar amount required under the given current/determined ECR to eliminate eligible service charges. This feature enables, for example, the user to determine any selective further choice they wish to employ between “SimuSweeps” and traditional physical sweep options. At FIG. 8, a Notes interface 700 allows a user/analysis to document information about the customer, competitor analysis or other information. It should be appreciated that FIG. 7 illustrates a choice of one (1) of five (5) options over which the pseudo/simulated ECR is selected for collected balances. The options include balances required to cover current included analysis item pricing. It should be appreciated that the Balance Builder system 10 may permit for pseudo or simulated rate (e.g., SimuSweep rates) to apply to balances left after cover a percentage of included analyzed services. The other four options are after adding to this calculation only, a predetermined percentage or dollar amount to services, or a dollar amount or percentage to otherwise required balances. As shown at 710 in FIG. 8, a “folder” type access control permits a user to navigate to and between the Checking Analysis Data Input interface 400 (FIG. 5), the Prospective Provider interfaces 500 and 500′ (FIGS. 6A and 6B), the Prospective Provider Summary Results with Price Modification Tool interface 600 (FIG. 7), and the Notes interface 700 (FIG. 8).

Referring again to the Balance Builder navigation interface 100 (FIG. 2), a Quick Analysis control 118 invokes a quick analysis functionality which enables a user to perform a new analysis directly from a previously set up Business and Present Provider information so that the user does not have to reenter the customer/bank information and pricing plans.

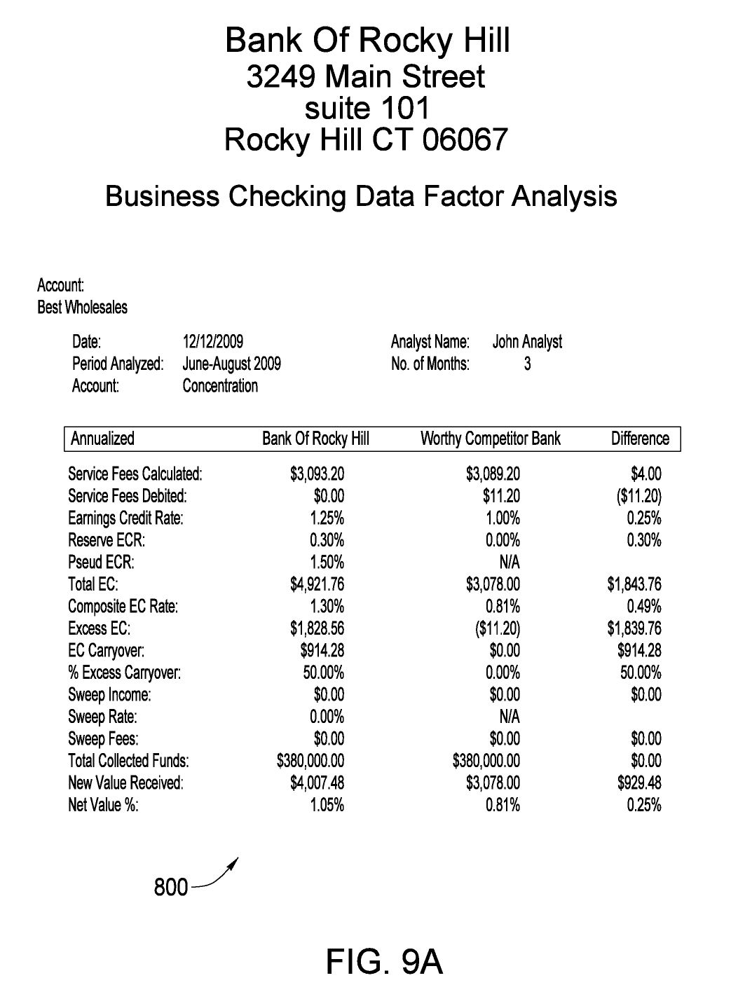

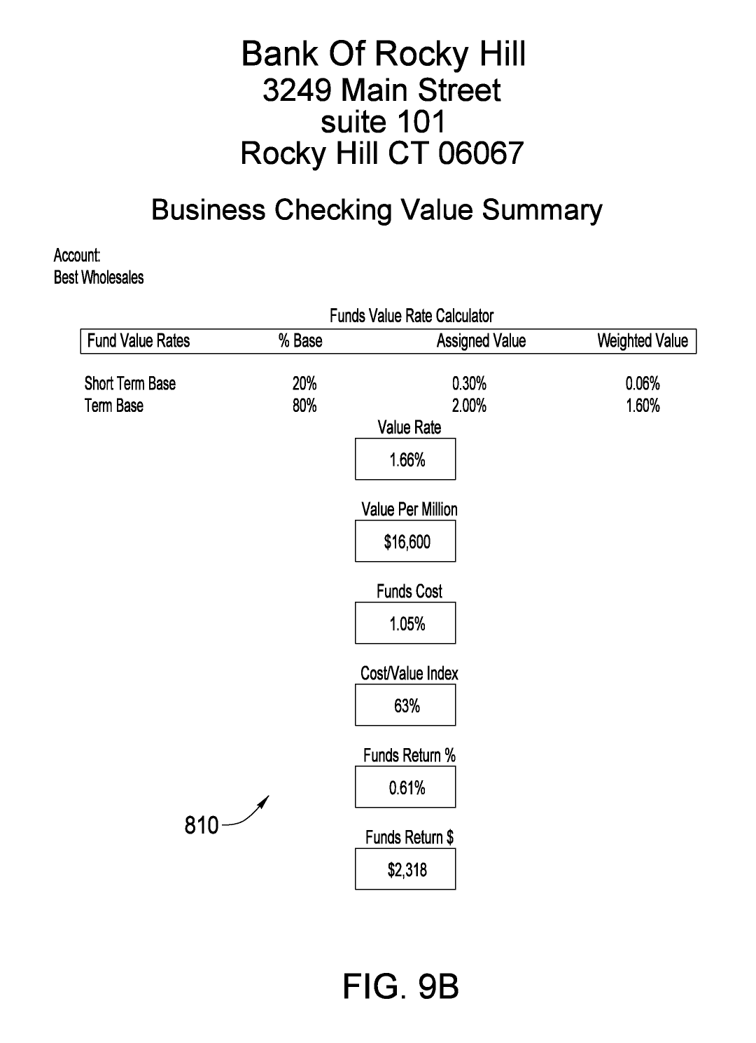

FIGS. 9A and 9B depict reports 800 and 810 that provide a summary of the Balance Builder analysis including underlying information and data for presentation and for assisting decision making.

Other features of the Balance Builder System 10 include, for example:

1. The Balance Builder system 10 provides the institution and, optionally, their customer with a complete results analysis including sweep options.

2. The most important results differentials include both “simulated” and “traditional” sweep options and the cost/value index.

3. Using assumptive or historical pricing details, comprehensive competitor comparison reports with only collected balance, service fee total amounts, fees charged and, if appropriate, average sweep, interest and fees data.

4. An extensive supplemental results factor presentation is provided automatically with each analysis.

5. The Balance Builder system 10 allows the user/institution to establish several different pricing plans in addition to unlimited ad hoc creations.

6. Analysis reports with complete detail can be optionally retained for future reference.

7. The Balance Builder system 10 can optionally store standard competitor pricing details.

As described herein the Balance Builder system 10 is dedicated to helping financial institutions (e.g., banks, credit unions, or other financial service institutions) develop a more dynamic “win-win” sales and operations environment by strategically integrating commercial checking and fee income growth strategies. One objective is to help the institutions develop new low-cost core deposits while producing additional value and service satisfaction for business checking customers, by:
Taking advantage of the full potential of business checking.
Developing a more profitable and dynamic business checking product line.
Competing more successfully against larger nationally based institutions.
Reducing the reliance on sweep accounts for excess checking balances.
Reducing the prominence of free checking in building business checking balances.
Creating additional fee income.
Employing “Full Value Business Checking” concepts selectively and discreetly.

Full Value Business Checking^{SM} is a service philosophy that embraces fair play and win-win bank/customer relationships. Simply put, the financial institution is entitled to fair payment for all services rendered, and the customer is entitled to fair payment for all funds deposited to the institution. This “fairness equation” entails quantitative evaluation of data and pricing based on mutually agreed upon service pricing and funds value rates. Full Value Business Checking principles can be applied to segmented customer groups and/or to differentiated bank products, and can be tailored to individual customers. Implementation options are simple for smaller-balance customers and more complex for significant customers, as needs and flexibility may dictate. The key to successful implementation is full and transparent data accountability and the willing participation of both the institution and its customers. As described herein, the Full Value Business Checking service approach can be easily expanded to a Full Value Business Banking perspective.

Some perceived benefits of the Balance Builder system 10 follow.

Larger Business Checking Balances

The Balance Builder system 10 demonstrates ways to generate larger business checking balances by offering commercial customers incentives based on detailed analysis of their payments practices and needs. The system 10 shows the user (e.g., a financial service professional) how to create dynamic analysis presentations designed to attract new accounts.

A Full Value Business Checking strategy improves the user's institution's net income by, for example:
Building lower-cost commercial checking balances.
Reducing dependence on unprofitable “free checking” accounts.
Synchronizing the value reaped and costs associated with customer relationships.
Converting selected swept funds back into business checking balances.
Reducing the effective cost of and thus increasing the attractiveness of fee based services to its customers.
Creating better accountability and control of fee waiver practices.

As described herein, “Full Value” and “Full Value Technology” allows the implementation of what the mind knows. And, avoids the frustration of not being able to implement what you can think by striving always for the best in technology and allowing it to encourage the mind to think the next creative thought.

From a service prospective, the Balance Builder system 10 provides the following features.

Full Value Business Checking—Full Value Business Checking reflects an expanded vision of the role, value and use of business checking in the modern banking and financial service arena. It begins with defining the unique value of business checking and identifying expanded product pricing elements that can be utilized, for plus and minus adjustments, in developing product return results.

Using the Balance Builder™ system 10 an institution may, for example:

1. Analyze the current competitive status.

2. Present a comprehensive array of action alternatives.

3. Clearly demonstrate the financial impact of various implementations.

4. Define implementation choices.

“Full Value Reserve”, for example:
Provides the institution/bank with an optional internet based storage facility to record unapplied earnings credits.
Provides the business customer a clear record of unapplied earnings credit activity.
Creates a unique internet facility for the institution/bank to detail its tailored program and describes utilization options available to the customer.

Moreover, the Balance Builder system 10 and service process are, for example:
Full Value Business Checking advocacy
Training and implementation assistance
Dynamic checking account analysis program
Discreet checking fees adjustment capability
Supplemental checking account analysis results implementation option
Tiered rate computations
Credit carryover control program assistance
On-line “Full Value Reserve” implementation
ACH intercept program
Multiple account consolidations
Multiple account distributions
Expanded loan interest reduction facility
SimuSweep implementation

At its core, the Balance Builder system 10 provides empowerment for an institutions success by empowering additional employees to participate more fully and with greater knowledge in the sales process resulting in better bank results.

The Balance Builder system 10 implements a dedicated service philosophy to help institutions/banks develop a more dynamic win-win sales and operations environment by strategically integrating commercial checking and fee income growth strategies. Some common questions, with the inventor's answers demonstrating some features and functions of the Balance Builder system 10, follows.

Q. Why are commercial checking balances important?

A. They are a low cost deposit, have a multi-year investment value, reflect core business relationship strength, and provide a fertile area for creative use and presentation.

Q. What is the investment value of commercial checking balances?

A. Traditionally, 2% more than the short term funds rate; 1% plus in today's super low rate environment.

Q. Why is the investment return so high?

A. Historically, a large part of the total commercial checking base, say 80%, has shown great stability and allowed for the utilization of a 3-4 year safe investment return factor in computing the composite commercial checking return value.

Q. Does that composite value factor into the Balance Builder system 10 technology?

A. Using the institution/bank's valuation parameters, each analysis performed using the Balance Builder system 10 is indexed against the institution/bank's valuation rate, which provides a quick reference check.

Q. What are the keys to building commercial checking balances?

A. Providing an attractively functional checking product while expanding the array of service fee product costs eligible for account analysis reduction is fundamental to success.

Q. How is value provided since commercial checking interest is not permitted?

A. By applying the imputed value of these deposits, in the form of an “earnings credits” to reduce the customer's hard dollar cost of institution/bank provided services is the recommended approach.

Q. What institution/bank services are eligible for fee/cost reductions?

A. It's the individual institution/bank's choice but the options include basic checking activity, trust service fees, payroll services, merchant services, and loan interest. Traditionally, most institution/banks have limited eligible costs to those directly related to checking activity.

Q. How does the Balance Builder system 10 assist in “recapturing” swept funds?

A. The Balance Builder system 10 assists a bank in applying, its designated, and usually higher, “pseudo funds rate” (special earnings credit rate) to excess funds (or the portion thereof the bank selects) that normally would be swept.

Q. Who should utilize the Balance Builder system 10 and its processes?

A. The larger an institution/bank's “sales staff”, the better will be their results.

Empowering staff to compete more effectively should be rewarding for the customers, institution/bank, and employees. In addition to Cash Management personnel, lenders, branch management, and other service sales personnel could be candidates. The broader a institution/bank's team of empowered employees, the better will be the institution/bank's results.

Q. How much detail should the institution/bank provide to the customer?

A. Only as much as the customer wants to hear in justifying the institution/bank's proposal. It's important that the banker understand the financial implications of recommendations to customers. Typical presentations utilize a combination of product strengths/utility, relationship strengthening implications and financial results.

Q. What is the Balance Builder system's function in the process?

A. To assist your institution/bank to enhance its overall commercial checking offering and build balances faster than they would grow otherwise while maintaining financial integrity and accountability over the process. Individual institution/banks will supplement their present programs simply or more expansively; the choice is theirs.

Specifics include:

1. Providing educational and training programs.

2. Engineering and offering “world class” analytics in the Balance Builder system 10.

3. Offering direct analysis support tailored to your needs.

4. Maintaining a dynamic internet accessed “Full Value Reserve” Program for your optional use in making excess earnings credits available to your business customers.

5. Developing high-volume data conversion programs for expanded depositor base usage.

6. Providing “intercept” guidance and future systems for specialized merchant services inclusion programs.

7. Maintaining a position of leadership in assisting institution/banks and businesses to maximize business checking potential.

Q. Can individual business checking accounts be tailored?

A. Absolutely. Each account analysis can be separately structured. The more common technique is to offer one to several special programs on a selected group basis with a few individually tailored “major accounts-special situations”.

It should be understood that the present invention is not limited with regard to the financial analysis tools described herein. Accordingly, although the invention has been described with reference to particular embodiments of comparing business checking account performance, it will be understood by one of ordinary skill in the art, upon a reading and understanding of the foregoing disclosure, that numerous variations and alterations to the disclosed embodiments will fall within the spirit and scope of this invention and of the appended claim.

What is claimed is:

1. A computer-implemented method of comparing competitive goods and/or services, the method including steps of:
receiving, by a processor, first pricing schedule information including fees assessed for providing goods and/or services to a customer by a first institution;
determining, by the processor, fees incurred by one or more accounts maintained by the customer during a predetermined time period at the first institution in accordance with the first pricing schedule information;
receiving, by the processor, second pricing schedule information including fees assessed for providing goods and/or services to the customer by a second institution;
determining, by the processor, fees incurred by the one or more accounts maintained by the customer during the predetermined time period at the second institution in accordance with the second pricing schedule information;
comparing, by the processor, the fees determined for maintaining the one or more accounts at the first institution to the fees determined for maintaining the one or more accounts at the second institution; and
presenting, on an output device coupled to the processor, a report to the customer including the comparison of the fees.

2. The method of claim 1, wherein the first institution is a current provider of the goods and/or services to the customer and the second institution is a prospective provider of the goods and/or services to the customer.

3. The method of claim 1, wherein the output device is a display device and the presenting step includes exhibiting the report to the customer as a user interface on the display device.

4. The method of claim 1, wherein the output device is a printer and the presenting step includes printing the report for the customer.

5. The method of claim 1, further includes:
receiving, by the processor, identification information regarding at least one of the first institution and the second institution.

6. The method of claim 1, wherein at least one of the first pricing schedule information and the second pricing schedule information includes a plurality of price levels of fees of the goods and/or services.

7. The method of claim 6, wherein the plurality of price levels includes a tiered pricing approach defining one or more thresholds at which fees for goods and/or services pass from a first price level to a second price level.

8. The method of claim 7, wherein the tiered pricing approach recognizes a distinction in a value of monetary funds held in the one or more accounts of the customer.

9. A system for comparing competitive goods and/or services provided to account holders, the system comprising:
a processor coupled to memory and an input-output controller;
an input device coupled to the input-output controller, the input device provides to the system data and information including balances in one or more accounts of an account holder, a schedule of current charges assessed by a financial institution to the one or more accounts and a schedule of prospective charges to be assessed to the one or more accounts;
computer implemented methods stored in the memory, the methods being executable by the processor to determine and compare performance at a present financial institution and at a prospective financial institution; and
a display device coupled to the input/output controller, the display device exhibiting comparison data detailing performance at the present financial institution and the prospective financial institution.

10. The system of claim 9, further including user interfaces generated by the computer implemented methods and provided by the processor to the display device.

11. The system of claim 10, wherein the account holder operates the input device to generate the data and information of one or more of its accounts.

12. The system of claim 10, wherein the account holder reviews the comparison data and, based thereon, makes an informed decision with respect to the management of the one or more accounts.
